(19) United States
(12) Patent Application Publication
(10) Pub. No.: US 2026/0225904 A1
(43) Pub. Date: Aug. 6, 2026

(54) METHOD FOR PRODUCTION OF BLUE AMMONIA

(71) Applicant: TOPSOE A/S, Kgs. Lyngby (DK)

(72) Inventors: Annette E. KRØLL JENSEN, Fredensborg (DK); Per Aggerholm SØRENSEN, Kgs. Lynby (DK); Per Juul DAHL, Vedbæk (DK); Ilayaraja KARUPPASAMY, Gentofte (DK)

(73) Assignee: TOPSOE A/S, Kgs. Lyngby (DK)

(21) Appl. No.: 19/147,594

(22) PCT Filed: Jan. 25, 2024
(86) PCT No.: PCT/EP2024/051754

§ 371 Date: Jul. 11, 2025

(30) Foreign Application Priority Data
Jan. 27, 2023 (DK) PA202300074
Dec. 21, 2023 (DK) PA202330430

(51) Int. Cl. C01C 1/04; B01D 53/047; B01D 53/48; B01D 53/62; C01B 3/025; C01B 3/56

(52) U.S. Cl. CPC C01C 1/0476; B01D 53/047; B01D 53/48; B01D 53/62; C01B 3/025; C01B 3/56; B01D 2257/30; B01D 2257/504; C01B 2203/0283; C01B 2203/042; C01B 2203/0475

(57) ABSTRACT

The present invention provides a method and system for producing blue ammonia, providing for a high percentage of carbon capture. The method and system of the invention may be used in any ammonia plant.

### FIELD OF INVENTION

The present invention provides a method and system for producing blue ammonia, providing for a higher percentage of carbon capture. The method and system of the invention may be used in any ammonia plant.

### BACKGROUND ART

Blue ammonia is a fossil fuel-based product produced with minimum emission of CO₂ to the atmosphere. It is seen as a transition product between conventional fossil fuel-based ammonia and green ammonia produced from green or renewable power, water and air. The CO₂ resulting from a blue ammonia production shall be stored permanently or converted into other chemicals. The main steps for producing blue ammonia are essentially the same as for producing conventional fossil fuel-based ammonia, the difference being that more of the carbon stemming from the carbon fuel is captured, providing a possibility for further processing.

The key here is that the blue ammonia does not release any carbon dioxide when used as fertilizer or burned. Currently available technology traps nearly all CO₂ generated during the conversion process making this fuel one of the first carbon free fuel options for mass use. Blue ammonia is considered an environmentally friendly product which can be used until sufficient renewable or green power is available for producing green ammonia.

If we can continue to diversify our power generation methods and create more and more renewable or green energy, the potential rises that we can perfect a method of green energy that produces hydrogen and ammonia as byproducts giving us a completely clean and safe power cycle.

Document WO2018/149641 discloses a process for the synthesis of ammonia from natural gas comprising conversion of a charge of desulphurized natural gas and steam, with oxygen-enriched air or oxygen, into a synthesis gas (11), and treatment of the synthesis gas (11) with shift reaction and decarbonation, wherein a part of the CO₂-depleted synthesis gas, obtained after decarbonation, is separated and used as fuel fraction for one or more furnaces of the conversion section, and the remaining part of the gas is used to produce ammonia.

The present invention is different from the setup disclosed in that document in that the present invention recovers at least one hydrogen rich tail gas from at least one H₂ PSA and at least one CO₂ depleted stream from the CO₂ removal step for fuel, carbon recycle, and optionally additional hydrogen production after further purification and separation and enables the use of a more carbon depleted fuel, thereby achieving a higher carbon recovery (up to more than 99% compared to the cited document.

### SUMMARY OF INVENTION

The present invention refers to a method, system and plant for producing ammonia with a high percentage of carbon capture, preferably >99% of carbon capture, when compared to the standard method where optimally between about 90-93% of carbon capture is achieved.

The method of the present invention provides for the following advantages:
Can be applied for grass root plants and to revamps;
Utilize the CO₂ removal step in the ammonia process to perform the complete CO₂ capture;
Enables >99% carbon recovery;
Reduces Ar entering the ammonia synthesis loop, thus reducing the required circulation flow in the loop and a required water wash off on the refrigeration off gas;
Reduces required ATR recycle flow (F) as the nitrogen content in the recycle stream is reduced compared to prior art;
Reduces cost of operation, since a compressor is not always needed to compress CO₂, at least under cryogenic conditions, where CO₂ is pressurized by different means, preferably pumped. The use of a pump increases the rich CO₂ product's pressure, in a less expensive manner than when using a compressor This also means less energy spending.

Said advantages are provided by a set of features, comprising:
CO₂ removal step is performed downstream to the hydrogen purification step, preferably but not exclusively in a cryogenic CO₂ removal unit or in a CO₂ PSA unit;
Natural gas firing is reduced to be used for pilot burners;
Carbon depleted gases mainly H₂ and N₂ used as fuel for the fuel systems;
Off-gases containing more than 40% vol. Methane and/or CO are redirected to the reforming section or to the desulfurization section as additional feed gas;

The present invention discloses a similar method and plant as in WO 2022/284434 but instead it provides for a hydrogen purification unit, such as a PSA or a NWU or other, upstream to a carbon removal unit, such as a cryogenic carbon capture unit or a CO₂ PSA unit or other suitable for the same purpose. With this new layout, the total cost of ownership for production of ammonia, can be reduced compared to the standard solution, where total cost of ownership includes CAPEX and OPEX for about 10 years.

High purity hydrogen is recovered in the hydrogen PSA unit and optionally an intermediate hydrogen rich fuel gas (tail gas) is sent to the fuel system, either directly or pre-combined with other streams.

The CO₂ rich PSA tail gas stream is sent to a CO₂ removal unit, preferably cryogenic, from which a high purity CO₂ product is recovered. Due to the cryogenic conditions, said CO₂ product or CO₂ rich stream can be pressurized, e.g. pumped to a required high CO₂ pressure without being compressed in one or more compressor units, which is the standard solution.

On the other hand, CO₂ depleted stream(s) can, after optionally further purification in one or more PSA and/or membrane unit(s), be pressurized and recycled back to steps a) and/or b) or fed to fuel systems, either directly or after pre-mixing with other streams. The CO₂ depleted stream from the CO₂ removal unit comprises the main part of unconverted hydrocarbons from the reforming step and the main part of unconverted CO from the shift step. Part of this stream can either be recycled directly to be used as reforming feed or part of the hydrogen can be separated on beforehand. The remaining part of the stream or the separated hydrogen can be used as fuel.

### BRIEF DESCRIPTION OF DRAWINGS

FIG. 1 shows an overview of a prior art process for producing ammonia according to an embodiment in WO 2022/248434, using Topsoe SynCOR Ammonia™ process:
a) Desulphurization
b₀) Pre-reforming
b) Reforming (ATR)
c) Shift section
d) CO₂ Removal
e) Nitrogen wash or PSA
f) Ammonia synthesis
h) Off gas recycle compressor
g) Fuel system(s)
Stream (4,8). Recycle off-gas stream.
Stream (5,7). Hydrogen rich fuel comprising nitrogen (replacing use of natural gas as fuel)
Stream 2. Flash gas from CO₂ removal

Where the CO₂ removal unit is upstream to the hydrogen purification unit.

FIG. 2 shows an overview of a prior art process for producing ammonia according to another embodiment in WO 2022/248434, using a steam reformer followed by an autothermal reformer in the synthesis gas generation:
a) Desulphurization
b0) Pre-reforming
b) Reforming (SMR)
b) Reforming (ATR)
c) Shift section
d) CO₂ removal
e) Nitrogen wash or PSA or methanator
f) Ammonia synthesis
h) Off gas recycle compressor
g) Fuel system(s)
Stream (4,8). Recycle off-gas stream.
Stream (5,7). Hydrogen rich fuel comprising nitrogen (replacing use of natural gas as fuel)
Stream (2). Flash gas from CO₂ removal

Where the CO₂ removal unit is also upstream to the hydrogen purification unit.

FIG. 3 shows an overview of a process for producing ammonia according to a preferred embodiment of the present invention, showing a hydrogen purification unit (e.g. PSA or nitrogen wash unit or other) upstream to a CO₂ removal unit (e.g. cryogenic CO₂ removal unit or a CO₂ PSA unit), wherein the remaining tail gas of the hydrogen purification unit enters said CO₂ removal unit.
a) Desulphurization
b0) Pre-reforming
b) Reforming
c) Shift section
d) Hydrogen purification unit
e) CO₂ removal
f) Ammonia synthesis
g) Fuel system(s)
h) Off gas recycle compressor

FIG. 4 shows an overview of a process for producing ammonia according to a preferred embodiment of the present invention, showing a first hydrogen purification unit (e.g. PSA or nitrogen wash unit or other) upstream to a CO₂ removal unit (e.g. cryogenic CO₂ removal unit or a CO₂ PSA unit), wherein a H₂ product C is generated and a hydrogen rich fuel stream D (with different or same composition as C) and the remaining tail gas of said hydrogen purification unit enters said CO₂ removal unit, generating a CO₂ rich stream (E) and a CO₂ depleted stream (K). Preferably there is low argon content in the feed (B) and a split stream of the hydrogen product is used as fuel, i.e. streams C and D have the same composition. In previous layouts, e.g. FIG. 3, there is a higher argon content and the hydrogen rich tail gas stream(s) have a different composition from C. In FIG. 4, the CO₂ depleted stream is directed to a second hydrogen purification unit, preferably a PSA (PSA-1) generating a CO₂ rich-stream (J) which is recycled back into the tail gas from the first hydrogen purification unit and a further CO₂ depleted stream (H) which is split between a first stream going into a third hydrogen purification unit, preferably a PSA (PSA-2) or a membrane and a separate stream (G) used as fuel gas. The third purification unit being a PSA, generates a hydrogen product (L) which is preferably mixed with hydrogen product (C) and has a number of different uses, e.g. in processes for production of chemicals such as ammonia or methanol, production of fuels, storage or other, and a stream F which is recycled to the ATR.

The streams D and G are used for fuel. Stream D has higher hydrogen content than stream G. Adjustment of stream D and G are performed dependent on carbon capture rate in question/requested.

Alternatively in case the third hydrogen purification unit is a membrane, stream L will be a hydrogen rich fuel stream. In this alternative case stream D, G and L are used for fuel.

### Definitions

Blue Ammonia is ammonia that is created from using fossil fuel where at least 90% of the Carbon in the fossil fuel is captured to be used in other products and processes or to be stored.

Catalyst poison means a substance that reduces the effectiveness of a catalyst in a chemical reaction. In theory, because catalysts are not consumed in chemical reactions, they can be used repeatedly over an indefinite period of time. In practice, however, poisons, which come from the reacting substances or products of the reaction itself, accumulate on the surface of solid catalysts and cause their effectiveness to decrease. For this reason, when the effectiveness of a catalyst has reached a certain low level, steps are taken to remove the poison or replenish the active catalyst component that may have reacted with the poison. Commonly encountered poisons include carbon on the silica-alumina catalyst in the cracking of petroleum; sulfur, arsenic, or lead on metal catalysts in hydrogenation or dehydrogenation reactions; and oxygen and water on iron catalysts used in ammonia synthesis.

Carbon capture, or carbon capture and storage (CCS), is a process that involves trapping the carbon dioxide (CO₂) at its emission source, preventing it from being released into the atmosphere, and then storing it in a way that it cannot escape. It is seen as a crucial strategy in efforts to combat global climate change. Once captured, the CO₂ is then transported and stored, usually underground in depleted oil and gas fields or deep saline aquifer formations.

Carbon Capture and Utilization (CCU) is preferred, involving capturing CO₂ and then converting it into useful products, such as chemicals (e.g. methanol), fuels, or building materials.

Contaminant means any substances or elements which are not desirable. Within the context of the present invention, contaminants comprise catalyst poisons.

Flue gas refers to the exhaust gas that is emitted as a byproduct of combustion processes, typically from the reformer unit or fired heater unit where the initial production of hydrogen-rich syngas occurs. Flue gas can also be a valuable source of heat for other parts of the process, and its CO₂ content can potentially be captured and utilized or stored to reduce greenhouse gas emissions.

Green Ammonia is ammonia that is produced by using green electricity, water and air.

Green Electricity is electricity produced from renewable resources such as wind, solar, Hydro or geothermal energy.

Ammonia synthesis catalysts mean, within the context of the present invention, any catalysts suitable for synthesizing ammonia. These catalysts are preferably iron (Fe) based, but may also comprise other catalysts suitable for the same purpose and operating at similar conditions.

Fuel systems comprise fuel systems for supply of fuel to the combustion side of tubular reformers and/or fired heaters and/or auxiliary boilers and/or gas turbines. These systems comprise one or more burners in which the incoming fuel streams are burned together with air at variable temperature and pressure.

Make-up ammonia or Traded Ammonia comprises ammonia (NH₃) and water (H₂O), preferably between 0.2 to 0.5 wt % of water content. It is usually supplied as a liquid but may also be a solution comprising different physical states. The effect of water comprised in ammonia feedstock in the ammonia decomposition process is primarily that due to poisoning the process, which usually has to take place at a high temperatures. This will increase process cost for ammonia decomposition as well as cost of construction materials in the plant. According to National Bureau of Standards ammonia shall conform to the following properties: minimum purity of 99,98% (wt), maximum 0,0005% (wt) oil and maximum 0.02% (wt) moisture.

A PSA unit means pressure swing adsorption unit. Typically, a mixture of gases, including hydrogen, is fed into the PSA unit under high pressure. The unit contains a material known as an adsorbent, which preferentially adsorbs certain gas molecules (e.g., CO, CO₂, N₂, CH₄) over others (in this case, hydrogen). As a result, the hydrogen gas passes through the unit while the other gases are adsorbed onto the material. Once the adsorbent material is saturated with the adsorbed gases, the pressure in the unit is reduced, which causes the adsorbed gases to desorb and be removed from the unit, which can then be purged with some of the produced hydrogen to remove any remaining adsorbed gases and regenerate the adsorbent material and the unit is repressurized.

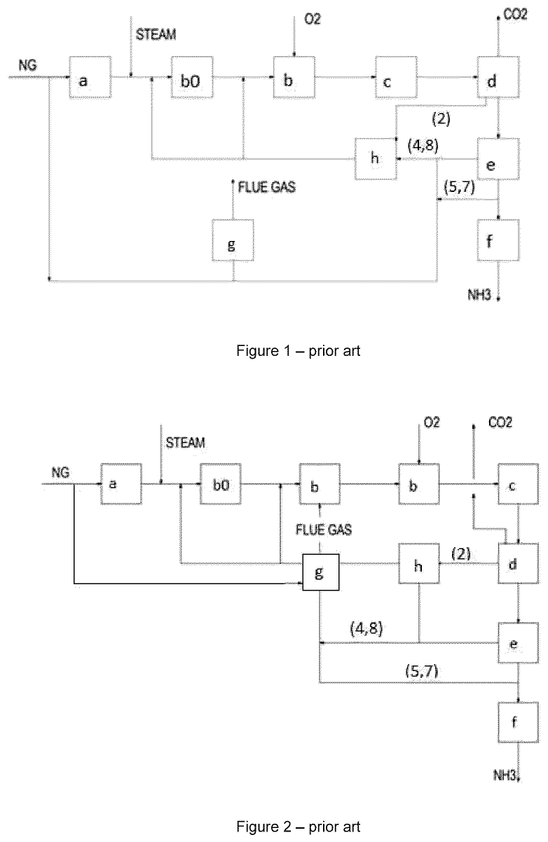

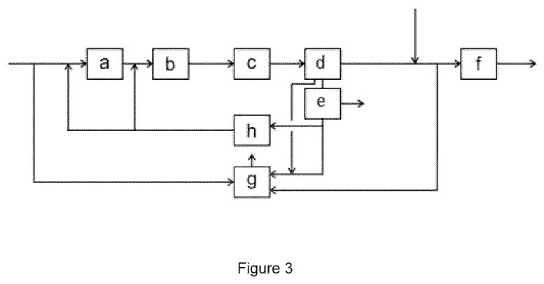

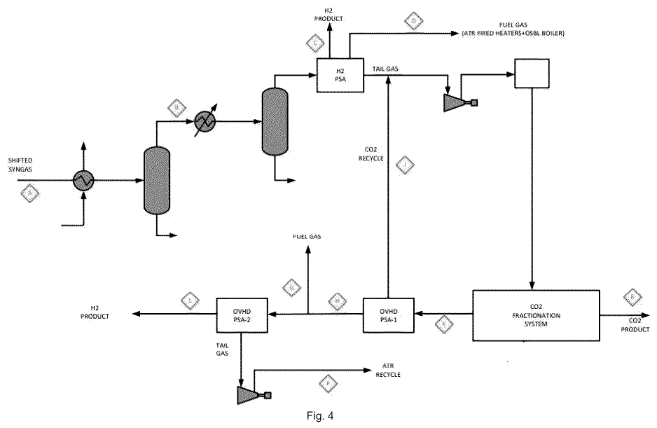

An overhead purification unit, e.g. PSA, in the context of hydrogen production or purification, refers to a purification unit (e.g. a Pressure Swing Adsorption (PSA) unit) that is positioned at a higher point or “overhead” in the process flow diagram. Said PSA can be e.g. a hydrogen PSA or a CO₂ PSA. Said purification unit can also be e.g. a membrane. In different parts of the preferred layout (FIG. 4), different purification units are optimal.

Shift reaction means Water-gas shift reaction (WGSR) or Shift reaction, the reaction of carbon monoxide and water vapor to form carbon dioxide and hydrogen:

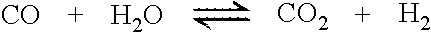

The WGSR is an important industrial reaction that is used in the manufacture of ammonia, hydrocarbons, methanol, and hydrogen. It is also often used in conjunction with steam reforming of methane and other hydrocarbons. In the Fischer-Tropsch process, the WGSR is one of the most important reactions used to balance the H₂/CO ratio. The water gas shift reaction is a moderately exothermic reversible reaction. Therefore, with increasing temperature the reaction rate increases but the carbon dioxide production becomes less favorable. Due to its exothermic nature, high carbon monoxide percentage is thermodynamically favored at low temperatures. Despite the thermodynamic favorability at low temperatures, the reaction is faster at high temperatures.

Shift unit or section means a process step where the shift reaction is performed.

Tail gas from a purification unit, e.g. a Pressure Swing Adsorption (PSA) unit refers to the gas that is vented out of the system during the depressurization and regeneration phases of the PSA cycle, typically containing the impurities that were initially present in the feed gas and were adsorbed onto the adsorbent material during the adsorption phase. These could include gases like carbon dioxide (CO₂), carbon monoxide (CO), methane (CH₄), nitrogen (N₂), and any residual non-adsorbed hydrogen. During the depressurization and regeneration phases, these adsorbed gases are desorbed from the adsorbent material and vented out of the system, forming the tail gas. The composition of the tail gas can vary depending on the specific feed gas composition and the type of adsorbent material used in the PSA unit. Optionally said tail gas can be recovered or treated e.g. by recycling it back into the process, using it as fuel, or treating it to remove certain components before it's discharged.

### DESCRIPTION OF THE INVENTION

Reducing CO₂ emission has become a bound task in the chemical industry. Production of ammonia using hydrocarbons as feedstock inevitably results in CO₂ formation which typically ends up in at least two CO₂ containing process streams, one almost pure CO₂ stream extracted from the syngas cleaning section and one or more flue gas streams. The CO₂ stream can be utilized for further chemical processing or stored. The CO₂ in the flue gas stream needs to be recovered before it can find similar use. The flue gas recovery process has a high operating and capital cost. It is therefore an advantage to limit the CO₂ content in the flue gas.

It is well known that CO₂ in the flue gas can be avoided by using carbon free fuels. In general hydrocarbons such as natural gas and carbon containing off gases originating from the process are used as fuels.

The advantage provided in WO 2022/248434 was that the main part of these fuels are replaced by an internal hydrogen rich stream and that the unavoidable off gas are recycled to the process. By applying this invention, it is possible to reduce the CO₂ content in the flue gas streams by more than 90%. Provided the pure CO₂ stream (1) is utilized or stored, then the product ammonia will be considered to be blue.

Traditional ammonia production involves utilization of off gases from ammonia recovery and syngas preparation steps to supplement natural gas as main fuels for fired heater/process furnaces. This would result in carbon emissions from flue gas stack which could partly be recovered by using a solution based on carbon capture technology. The recovery rate for such a plant, including carbon recovery from flue gases would not be higher than 90% and is a capital intensive process.

With the proposed layout, a high purity hydrogen product stream and hydrogen rich gas streams are recovered in the hydrogen purification unit (e.g. PSA, other) and the remaining CO₂ rich tail gas, coming out of said hydrogen purification unit, is sent to a CO₂ removal unit, preferably a cryogenic CO₂ removal unit, from which a high purity CO₂ product (CO₂ rich stream) is recovered and pressurized. An ammonia synthesis gas is made by adding nitrogen to said high purity hydrogen product stream. In a preferred embodiment, using a cryogenic CO₂ removal unit, due to cryogenic conditions the liquid CO₂ product is pressurized, preferably pumped to the required high CO₂ pressure instead of being compressed which is the standard solution, so no compression unit is required. Savings in both energy and investment in facility/equipment as well as during operation are achieved with this new layout (FIG. 3).

Advantageously one or more hydrogen rich tail gas or fuel streams from hydrogen purification unit, e.g. a PSA, may be sent to the fuel systems, either directly or after pre-mixing with other streams, such as one or more of the CO₂ depleted stream(s) from the CO₂ removal unit after optionally further purification/separation or part of the hydrogen and nitrogen rich stream directed to ammonia synthesis.

The CO₂ depleted stream from the CO₂ removal unit can be partly recycled as reformer feed and partly used as fuel. Optionally, the fuel part can be separated from the stream. This can optionally be done using an overhead PSA for generating a CO₂ containing stream which is recycled back to the inlet of the CO₂ removal unit. The remaining tail gas stream from the overhead PSA can be partly used as fuel before further separated in a second overhead PSA or membrane unit into optionally a further hydrogen product stream, a hydrogen rich fuel stream and a carbon rich recycle stream which is sent to steps a) and/or b).

This lean process results in significant carbon emission reduction, between approximately 90 and more than 99% carbon recovery and will be an economical solution when compared to the commonly used methods for production of blue ammonia.

### Preferred Embodiments

1. Process for producing ammonia comprising the steps of:
a) Removing sulphur and other contaminants from a hydrocarbon feed;
b) Reforming the hydrocarbon stream from step a) and obtaining synthesis gas comprising CO, CO₂, H₂, H₂O and CH₄;
c) Shift reaction step, reducing the CO content;
d) A first hydrogen purification step of stream (B), resulting in a hydrogen product (C), a hydrogen rich gas stream(s) (D) and a CO₂ rich tail gas stream(s), wherein:
   said hydrogen rich gas stream(s) (D) is processed as fuel;
   nitrogen is added to said hydrogen product (C, L) to obtain a synthesis gas stream comprising N₂ and H₂ for ammonia synthesis; and
   said CO₂ rich tail gas stream(s) undergoes a CO₂ removal step, originating a CO₂ product (E) and a CO₂ depleted stream (K), said CO₂ product being pressurized and said CO₂ depleted stream being further processed in a second purification step, such that:
      i) CO₂ containing stream (J) is recycled to the CO₂ removal inlet;
      ii) stream (H) is split between stream (G) which is processed as fuel (g) and the remaining being further processed in a third purification step;
      iii) stream (F) from said third purification step, being sent back to step a) or b) and/or
      iv) stream (L), an optional hydrogen product stream from said third hydrogen purification step, being added to hydrogen product (C) or alternatively processed as fuel.

1.1 The reformer used in step b) is preferably an autothermal reformer (ATR) but may be any other suitable reformer.

1.2 The gas from step b) is subject to shift reaction wherein the CO content is preferably reduced to below 4% vol.

1.3 The CO₂ rich stream obtained after the CO₂ removal step preferably comprises more than 98% vol of CO₂ and can be stored or used for production of other chemicals or fuels, such as urea, methanol, synthetic fuel or other suitable chemical or fuel.

1.4 The hydrogen rich stream obtained in step d) preferably contains more than 93% vol H₂ on dry basis.

1.5 The pressure inlet the hydrogen purification step d) is preferably 30-31 bar g (A).

1.6 The L stream is a hydrogen product stream when the third purification unit is a PSA and a fuel stream when the third purification unit is a membrane.

1.7 Process according to any one of the preceding embodiments wherein the hydrocarbon and carbon oxide content in the hydrogen rich stream is less than 80 ppmv.

1.8 Process according to any one of the preceding embodiments wherein the CO₂ rich tail gas comprises more than 99.90% of the hydrocarbons and carbon oxides in the gas leaving the shift reaction, preferably more than 99.95% vol, more preferably more than 99.98% vol.

2. Process according to embodiment 1 wherein a hydrogen rich stream resulting from a hydrogen purification step comprises more than 99.5% vol. hydrogen, preferably more than 99.9% vol.

In case there is nitrogen in the feed (B) to the hydrogen purification step (FIG. 4), the nitrogen is preferably passing the first PSA with the hydrogen product stream (C). The hydrogen purity of the hydrogen product stream will reduce in accordance with the nitrogen amount contained in the hydrogen product stream and said product stream can contain approximately 97% or more hydrogen, e.g. 97,86%.

In this optimized layout nitrogen from the feed is passing the PSA and is going with the hydrogen product. This means that the hydrogen product stream contains less hydrogen but on the other hand the layout is more efficient than when we have to separate nitrogen from the stream and thereby obtain a higher hydrogen purity, approximately 99%.

In particular, the increased nitrogen content in stream B will preferably increase nitrogen content in stream C without affecting other impurities, maintaining the hydrogen purity at above 99%, excluding nitrogen.

Said first hydrogen purification step takes place in one of PSA or NWU.

3. Process according to any one of embodiments 1 to 2 wherein a CO₂ depleted stream (K) is sent to a second (hydrogen or CO₂) purification unit producing a CO₂ rich recovery recycle stream (J) to the CO₂ removal unit and a gas stream (H) split between a (i) hydrogen rich stream (G) to be processed as fuel (g) and (ii) another hydrogen rich stream being sent into a third (hydrogen) purification unit, e.g. a PSA or membrane, producing a i) carbon-rich tailgas recycle (F) to be pressurized and sent to step a) or b) and ii) a second hydrogen rich stream (L) to be processed as fuel (g) when the third purification unit is a membrane or as a hydrogen product stream, when said third purification unit is a PSA.

There is only minor CO₂ inlet the third PSA. It will therefore be a hydrogen purification unit (PSA or membrane). Having an additional hydrogen product stream (L) allows for a lower CAPEX, since overall more hydrogen is recovered when comparing with previous layouts.

At least one of said second and third hydrogen purification unit(s) are preferably PSAs, preferably overhead PSAs.

In a most preferred embodiment, both second and third hydrogen purification units are overhead PSAs.

Process according to embodiment 3 wherein at least one of said second and third hydrogen purification unit(s) are preferably NWUs.

4. The CO₂ product (E) results from a cryogenic CO₂ removal step is pressurized, preferably by pumping, and is provided at the required pressure between 20 to 300 barg, preferably between approximately 140 and 190 barg.

5. Process according to the previous embodiment wherein a CO₂ product, resulting from a cryogenic CO₂ removal step, is pumped to the required pressure.

6. Process according to any one of embodiments 1 to 3 wherein a CO₂ product resulting from a PSA CO₂ removal step is compressed to the required pressure.

7. Process according to any one of the preceding embodiments wherein at least one of the hydrogen rich tail gas stream(s) (D) obtained from the hydrogen purification step is directly fed to the fuel systems. Alternatively said one or more hydrogen rich tail gas stream(s) is premixed with other streams in the process before being fed into the fuel systems.

7.1 Process according to any one of the preceding embodiments wherein a hydrocarbon fuel (e.g. CH₄), a fuel stream G being a split stream of stream H from the second purification unit, a hydrogen rich gas from the hydrogen purification step (D), optionally (L) processed as fuel stream and part of the hydrogen rich stream optionally comprising N₂ and H₂ for ammonia synthesis are either premixed or fed separately to the fuel systems g).

8. Process according to any one of the preceding embodiments comprising an adiabatic pre-reforming step b₀) of the hydrocarbon stream from step a), before step b), wherein a synthesis gas comprising CH₄, CO, CO₂, H₂ and H₂O is obtained.

9. Process according to any one of the preceding embodiments, wherein the amount of air to the air blown secondary reformer is adjusted to obtain a specific molar ratio of N₂ and H₂ between 1 to 2.5 and 1 to 3.5, in the stream from a methanation reactor.

10. Process according to embodiment 1 wherein the stream obtained from step d) comprises N₂ and H₂ in a molar ratio of 1 to 3.0.

Process according to any one of the previous claims wherein during and/or after the first purification step, streams C and D have the same composition.

11. Plant for producing ammonia according to the process in claims 1 to X, comprising:
a) a desulfurization section;
b) a reforming section;
c) a shift section;
d) a first hydrogen purification unit or section;
e) a CO₂ removal unit or section;
f) a second (hydrogen or CO₂) purification section;
g) a third (hydrogen) purification section (PSA or a membrane);
h) an ammonia synthesis section;
i) fuel systems, and
h) a tail-gas compressing section,
wherein
   said first hydrogen purification unit is upstream to said CO₂ removal section,
   a second purification section is downstream to the CO₂ removal section;
   a third purification unit (PSA or a membrane) is downstream to the second purification section; and
   said tail gas compressing section is comprised within the third purification section.

A pressurizing section (e.g. a pump) of CO₂ is comprised within the CO₂ removal section.

11.1. Plant for producing ammonia according to embodiment 11, wherein the carbon content in the combined flue gases from the fuel systems is less than 5%, preferably less than 1% of the combined carbon content in the hydrocarbon feed and the hydrocarbon fuel.

11.2. Plant according to embodiment 11 wherein the reforming section b) comprises an autothermal reformer or a tubular reformer followed by an autothermal reformer or a tubular reformer, followed by an air blown secondary reformer.

11.3. Plant according to embodiment 11 wherein the shift section comprises a high temperature (HT) reactor or a medium temperature (MT) reactor or a low temperature (LT) reactor or any combination of at least two of these.

11.4. Plant according to embodiment 11.3 wherein two of i) HT reactor; ii) MT reactor; and/or iii) LT reactor are combined in series.

11.5. Plant according to embodiment 11 and any one of its sub-embodiments, wherein the fuel systems supply fuel to tubular reformers and/or fired heaters and/or auxiliary boilers and/or gas turbines.

11.6. Plant according to embodiment 11.5, wherein the fuel systems comprise one or more burners.

12. Plant according to embodiment 11 and any one of its sub-embodiments, wherein said pressurizing section may comprise a compressor or a pump or any other suitable means for pressurizing the above mentioned CO₂ rich tail gas.

13. Plant according to embodiment 11, wherein the hydrogen purification unit is one or more pressure swing adsorption (PSA) unit(s).

14. Plant according to embodiment 11 wherein the hydrogen purification unit is another suitable unit or section for a similar purpose.

15. Plant according to any one of embodiments 11 to 14, wherein the CO₂ removal unit is cryogenic and includes a pressurizing section.

15.1 Plant according to embodiment 15 wherein said pressurizing section comprised within a CO₂ cryogenic unit is a pump.

16. Plant according to any one of embodiments 11 to 15 wherein the CO₂ removal unit is a pressure swing adsorption (PSA) unit or a gas membrane or other suitable means for the same or a similar purpose.

16.1 Plant according to any one of embodiments 11 to 16 wherein the CO₂ depleted stream from the CO₂ removal unit is further separated in one or more PSA or membrane unit(s) to a CO₂ containing recycle stream sent to the inlet of the CO₂ removal unit, a carbon containing recycle stream to a) and/or b), one or more hydrogen rich fuel gas streams and optionally a further hydrogen product stream.

17. Plant according to any one of embodiments 11 to 16 wherein the reforming section comprises an HTER in parallel or in series with an ATR.

18. Plant according to any one of embodiments 11 to 17 wherein a pre-reforming unit is upstream to the reforming section.

19. Plant according to any one of embodiments 11 to 18 wherein the fuel systems g) comprise one or more tubular reformer(s), fired heater(s), auxiliary boiler(s) and gas turbine(s).

20. Plant according to embodiment 19 wherein fuel systems comprise one or more burners.

21. Plant for producing ammonia according to any one of embodiments 11 to 20, wherein the carbon content in the combined flue gases from the fuel systems g) is less than 5% vol, preferably less than 1% vol of the combined carbon content in the hydrocarbon feed and the hydrocarbon fuel.

22. Plant according to any one of embodiments 11 to 21 wherein the reforming unit b) comprises an autothermal reformer or a tubular reformer followed by an autothermal reformer or a tubular reformer followed by an air blown secondary reformer. A tubular reformer is also known as a steam reformer.

23. Plant according to any one of embodiments 11 to 22 wherein the shift section c) comprises a high temperature (HT) reactor or a medium temperature (MT) reactor or a low temperature (LT) reactor or any combination of at least two of these.

24. Use of CO₂ obtained by the method in embodiment 1 for CO₂ storage.

25. Use of CO₂ obtained by the method in embodiment 1 to produce chemicals, such as ammonia, urea, methanol, synthetic fuel or other suitable chemical.

### EXAMPLE

The layout in FIG. 4 comprises an oxygen fired autothermal reformer or ATR. The argon amount from the ASU is in the given example limited to 300 ppm argon in oxygen and 100 ppm argon in nitrogen from the ASU. The pressure level in the front-end and low argon content in the feed ensures a high H₂ PSA efficiency. Due to the low argon content in the feed, argon may pass to the hydrogen product to obtain a higher PSA efficiency. Maximal argon in the fuel stream(s) is however preferred and aimed for at the given H₂ PSA efficiency, which is set by the overall fuel balance.

In the given example the H₂ PSA efficiency is 91.3% (Stream C+D). Stream D is used for fuel adjustment ISBL to obtain the required carbon capture rate from SOR to EOR. There is no export fuel requirement in this case. Stream C and D have the same composition in the given example but may also variate in composition.
When the H₂ PSA efficiency (stream C+D) is set optimal with respect to the fuel balance, argon distribution can then be optimized in the streams.
For the total H₂ Product stream (Stream C+L) the following apply
   Argon content to be minimized at the given H₂ PSA efficiency.
   Nitrogen content can be maximized at the given H₂ PSA efficiency.
   The total amount of oxygen atoms (calculated as CO+H₂O+2*CO₂+2*O₂) must be less than 5 ppm vol.
Stream G (one or more fuel streams): Hydrogen rich fuel stream. Ar is preferably to be recovered as much as possible in this stream. Pressure: 1.5 bar g is sufficient.
   Argon recovery to be maximized in the fuel stream(s).
   Hydrogen content to be maximized.
   Carbon containing components to be minimized.
Stream F: ATR recycle stream. Up concentration of carbon components, minimum N₂, Ar, H₂ is preferred.
   Recovery of carbon containing components to be maximized.
   Hydrogen, nitrogen and argon content to be minimized.

Hydrogen product stream (stream C+L): Minimum argon is preferred. (There is not a maximum argon limit as a target, the resulting amount of argon in the hydrogen product can be handled in the loop by purging if required). Maximum balance N₂ is preferred/optimal.

The layout with H₂ PSA, CO₂ fractionation system followed by two overhead PSAs have the advantage that a high H₂ recovery fraction is obtained at the given pressure level with the low argon content in the feed stream. This results in a reduced ATR recycle stream (F) and overall reduced front-end size of the plant leading to lower CAPEX, OPEX and levelized cost of ammonia in comparison with a layout with purification system consisting of an amine based CO₂ removal unit and a nitrogen wash unit (NWU).

High Nitrogen content in the natural gas feed to the ammonia plant gives the cryogenic solution an advantage over the NWU where more nitrogen ends up in the recycle off gas to the ATR.

1. A process for producing ammonia comprising the steps of:
a) removing sulphur and other contaminants from a hydrocarbon feed;
b) reforming the hydrocarbon stream from step a) and obtaining synthesis gas comprising CO, CO₂, H₂, H₂O and CH₄;
c) conducting a shift reaction step, reducing the CO content;
d) conducting a first hydrogen purification step of shifted stream, resulting in a hydrogen product, hydrogen rich gas stream(s) and a CO₂ rich tail gas stream(s),
wherein:
said hydrogen rich gas stream(s) being processed as fuel;
nitrogen is added to said hydrogen product to obtain a synthesis gas stream comprising N₂ and H₂ for ammonia synthesis; and
said CO₂ rich tail gas stream(s) undergoes a CO₂ removal step, originating a CO₂ product and a CO₂ depleted stream, said CO₂ depleted stream being further processed in a second purification step, providing a CO₂ rich recovery recycle stream to the CO₂ removal inlet and a gas stream to be split between a hydrogen rich stream to be processed as fuel and another hydrogen rich stream being further processed in a third purification step, producing a i) carbon-rich tail-gas recycle to be pressurized and sent to step a) or b) and ii) a second hydrogen rich stream, an optional hydrogen product stream from said third hydrogen purification step, being added to hydrogen product or alternatively processed as fuel.

2. The process according to claim 1 wherein the hydrogen purity of the hydrogen product stream resulting from a hydrogen purification step is reduced from more than 99%, the more nitrogen is present in the hydrogen product stream, to more than 96% hydrogen.

3. The process according to claim 1 wherein the CO₂ product results from a cryogenic CO₂ removal step is pressurized and is provided at the required pressure between 20 to 300 barg.

4. The process according to claim 1, wherein at least one of the hydrogen rich tail gas stream(s) obtained from the hydrogen purification step is directly fed to the fuel systems, either directly or after being mixed with other streams.

5. The process according to claim 1, wherein a hydrocarbon fuel, a fuel stream being a split stream of stream H from the second purification unit, a hydrogen rich gas from the hydrogen purification step, optionally processed as fuel stream and part of the hydrogen rich stream optionally comprising N₂ and H₂ for ammonia synthesis are either premixed or fed separately to the fuel systems g).

6. The process according to claim 1, comprising an adiabatic pre-reforming step b₀) of the hydrocarbon stream from step a), before step b), wherein a synthesis gas comprising CH₄, CO, CO₂, H₂ and H₂O is obtained.

7. The process according to claim 1, wherein the stream obtained from step d) comprises N₂ and H₂ in a molar ratio of 1 to 3.0.

8. The process according to claim 1, wherein the carbon content in the combined flue gases from the fuel systems g) is less than 5% vol of the combined carbon content in the hydrocarbon feed and the hydrocarbon fuel.

9. The process according to claim 1, wherein during and/or after the first purification step, streams C and D have the same composition.

10. A plant for producing ammonia according to the process in claim 1, comprising:
a) a desulfurization section;
b) a reforming section;
c) a shift section;
d) a first purification unit or section;
e) a CO₂ removal unit or section;
f) a second purification section;
g) a third purification section;
h) an ammonia synthesis section;
i) fuel systems, and
h) a tail-gas compressing section,
wherein
said first purification unit is upstream to said CO₂ removal section,
a second purification section is downstream to the CO₂ removal section;
a third purification unit is downstream to the second purification section; and
said tail gas compressing section is comprised within the third purification section, and wherein the CO₂ depleted stream is processed in the second purification section, providing a CO₂ rich recovery recycle stream to the CO₂ removal unit's inlet and a gas stream to be split between a hydrogen rich stream to be processed as fuel in fuel systems and another hydrogen rich stream being further processed in a third purification section, thereby producing a v) carbon-rich tail-gas recycle to be pressurized in a tail gas compressing section and sent back to step a) or b) and vi) a second hydrogen rich stream to be processed as fuel when the third purification unit is a membrane or as a hydrogen product stream, when said third purification unit is a PSA.

11. The plant according to claim 10, wherein the reforming section b) comprises an autothermal reformer or a tubular reformer followed by an autothermal reformer or a tubular reformer, followed by an air blown secondary reformer.

12. The plant according to claim 10, wherein the shift section comprises a high temperature reactor or a medium temperature reactor or a low temperature reactor or any combination of at least two of these.

13. The plant according to claim 12, wherein two of i) HT reactor; ii) MT reactor; and/or iii) LT reactor are combined in series.

14. The plant according to claim 10, wherein the fuel systems supply fuel to tubular reformers and/or fired heaters and/or auxiliary boilers and/or gas turbines.

15. The plant according to claim 10, wherein the fuel systems comprise one or more burners.

16. The plant according to claim 10, wherein the first hydrogen purification section comprises one or more pressure swing adsorption unit(s).

17. The plant according to claim 10, wherein both second and third purification sections are overhead PSAs, the second purification section comprising one or more of hydrogen or CO₂ PSAs and the third purification section being one or more hydrogen PSA(s) or membrane(s).

18. The plant according to claim 10, wherein said pressurizing section comprises a compressor or a pump or any other suitable means for pressurizing the CO₂ product or CO₂ rich tail gas.

19. The plant according to claim 10, wherein the CO₂ removal section is cryogenic and comprises a pressurizing section or tail gas compressing section.

20. The plant according to claim 10, wherein said pressurizing section is a pump and wherein the CO₂ product resulting from a cryogenic CO₂ unit is pressurized by pumping and is provided at the required pressure between 20 to 300 barg.

21. The plant according to claim 10, wherein the reforming section comprises an HTER in parallel or in series with an ATR.

22. The plant according to claim 10, wherein a pre-reforming unit is upstream to the reforming section.

23. The plant according to claim 10, wherein the fuel systems comprise one or more tubular reformer(s), fired heater(s), auxiliary boiler(s) and gas turbine(s).

24. The plant according to claim 23, wherein fuel systems comprise one or more burners.

25. The plant according to claim 10, wherein the reforming unit b) comprises an autothermal reformer or a tubular reformer followed by an autothermal reformer or a tubular reformer followed by an air blown secondary reformer.

26. The plant according to claim 10, wherein the shift section c) comprises a high temperature reactor or a medium temperature reactor or a low temperature reactor or any combination of at least two of these.
